(19) United States
(12) Patent Application Publication
(10) Pub. No.: US 2023/0032970 A1
(43) Pub. Date: Feb. 2, 2023

(54) Pressure Injury Relief System

(71) Applicants: Ashish Purekar, Rockville, MD (US); Pablo Sztein, Silver Spring, MD (US); Gregory Hiemenz, Silver Spring, MD (US); Amit N. Shah, North Potomac, MD (US)

(72) Inventors: Ashish Purekar, Rockville, MD (US); Pablo Sztein, Silver Spring, MD (US); Gregory Hiemenz, Silver Spring, MD (US); Amit N. Shah, North Potomac, MD (US)

(21) Appl. No.: 17/875,511

(22) Filed: Jul. 28, 2022

Related U.S. Application Data
(60) Provisional application No. 63/227,061, filed on Jul. 29, 2021.

(51) Int. Cl. A61G 7/057; A61G 7/053

(52) U.S. Cl. CPC A61G 7/057; A61G 7/0536

(57) ABSTRACT

The present invention is a pressure injury relief system for patient recovery and transport comprising a plurality of regions of open-cell foam support material each being separately tuned for the portion of the patient body that it is supporting. At least one cut-out region occurs between opposing padded regions to correspond to a patient's bony prominence when said patient lies on said cushioning support.

### CROSS-REFERENCE TO RELATED APPLICATION

The present application derives priority from U.S. provisional application Ser. No. 63/227,061 filed on 29 Jul. 2021.

### BACKGROUND OF THE INVENTION

### Field of the invention

The present invention relates to a system to reduce pressure-induced soft tissue injury.

### Description of the Background

While the treatment and stabilization of medical conditions are the primary objectives of caregivers, the prevention of secondary injury is also important for optimizing overall outcomes and recovery time. For immobile and immobilized patients, secondary injuries such as pressure-induced skin and soft tissue injury (PSSTI) can start to form soon after injury and progress as the patient moves through the chain of care. These injuries may go unnoticed, and even be exacerbated, during care delivered in medical treatment facilities where resources and capabilities are sparse compared to higher level-of-care facilities. Ultimately, PSSTI can complicate medical treatment and tax scant resources.

PSSTI arises due to extended duration of pressure (contact force and friction) and prolonged exposure to wetness. Areas primarily affected include the back of the head, shoulders, elbows, lower back/sacrum, and heels. In Operation Iraqi Freedom, 38% of admissions to the polytrauma rehabilitation center had pressure-related injuries. In these instances, occipital lesions (i.e., back of the head) were approximately half of the stage II or greater pressure injuries. Similar rates were found for casualties returning from Afghanistan. In hospital settings, an automated approach to PSSTI minimization uses air mattresses or mattress overlays with discrete cells that inflate/deflate to redistribute pressure.

Devices developed to reduce the incidence of PSSTI fall into two categories—passive support surfaces and active support surfaces. Passive support surfaces impart low contact pressure to patients and include conformable foam mattresses and mattresses with alternate fill materials such as air, water, gel, fiber, or beads. Active support surfaces include mattresses that provide alternating pressure, air fluidized beds, and low air loss beds. There is currently insufficient data to establish the superiority of one PSSTI reduction approach over another.

While an active support surface has shown effectiveness in reducing PSSTI, a lack of mechanical reliability of the pump used to periodically redistribute air in the cells has been identified as a key failure point. Moreover, the noise produced by the pump interferes with recuperation. Active systems are unsuitable in military and certain pre-hospital settings due to their size, weight, power requirement, cost, and noise during use.

Passive support surfaces may provide a superior combination of PSSTI reduction effectiveness, size, simplicity, and weight compared to active methods.

### SUMMARY OF THE INVENTION

The present invention is a support cushioning system to reduce PSSTI using a system of aligned or positioned support pads capable of reducing contact pressure and friction underneath a patient. The support pads may be constructed of one or more layers of a soft, compressible material such as polyurethane or silicone foam. The density and stiffness properties of each pad can be tailored to the region of the body that is supported through selection and arrangement of the one or more layers of compressible material.

The support cushioning system preferably also includes indicia comprising text instructions or illustrations to guide arrangement of the support cushioning system and placement of the patient relative to the cut-outs/gaps.

The support pads are preferably constructed of materials, such as foams, that can be compressed to reduce occupied volume when in a packed configuration (e.g., for storage).

The layers of compressible material is also preferably encapsulated by a vented and otherwise air- or water-sealed cover to protect the pads inside from being soaked by bodily fluids and or water, e.g., if being washed. The cover may be non-removable and adhered to the pads.

The cover can have integrated pressure relief valves or vents to prevent air holding due to rapid changes in ambient pressure such as during aeromedical evacuation. The valve or vent would further prevent intrusion of fluids into support cushioning system.

The support cushioning system can be sewn into or non-permanently attached to other patient supporting or patient movement devices such as a stretcher or litter.

A network of webbing can be sewn or attached to the support pads. The network of webbing can tie multiple sections of support pads together into a single unit. The network of webbing may further have handles for lifting and transporting the patient. The network of webbing can be sewn to the support pads or non-permanently attached to the support pads. The network of webbing may also allow the cushioning system to be attached to other patient movement devices such as patient litters or stretchers.

Key benefits of the system can be summarized as follows:
Ability to tailor support to areas of the body which are highly susceptible to PSSTI such as the occiput, scapula, and sacrum to reduce contact pressure and friction.
Targeted areas of the body can be completely unloaded by the design of or by simply repositioning support pads.
Ability to improve air flow and enable fluid drainage in order to decrease moisture below the patient.
Ability to improve air flow and reduce skin surface temperature in order to reduce skin and soft tissue injury.
Light weight and a small-packed volume allows the cushioning system to be carried and used in austere environments.
Integration with other patient transport and patient movement devices.
Simple and quick deployment—The support surfaces stand ready to rapidly deploy from the stowed configuration to regain their full volumes and accept a patient.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a perspective of a support surface system including distinct support regions, 1, 2, 3, 4.

FIG. 2 is a perspective of the support surface system in FIG. 1 with central pads separated to form a space 5 between the pads.

FIG. 3 is a perspective of a support surface system consisting of distinct regions, 1, 2, 3, 4, with customized density and stiffness foam properties. The pad includes a cut-out region, 5.

FIG. 4 represents the support surface system in FIG. 3 with a support insert 12, inserted into the cut-out region 5 from FIG. 3 to produce a contiguous support surface.

FIG. 5 presents the support surface of FIG. 3 with cover fabric 15, 16 over the foam materials.

FIG. 6 presents a support surface system with a fabric flap 18 used to assist with packing.

FIG. 7 presents a support surface system packed and held in place using the fabric flap 18 from FIG. 6.

FIG. 8 is a perspective view illustrating how the repositioning of pads 1-4 reduce sacral pressure.

FIG. 9 is a perspective view illustrating how cutout 5 reduces sacral pressure.

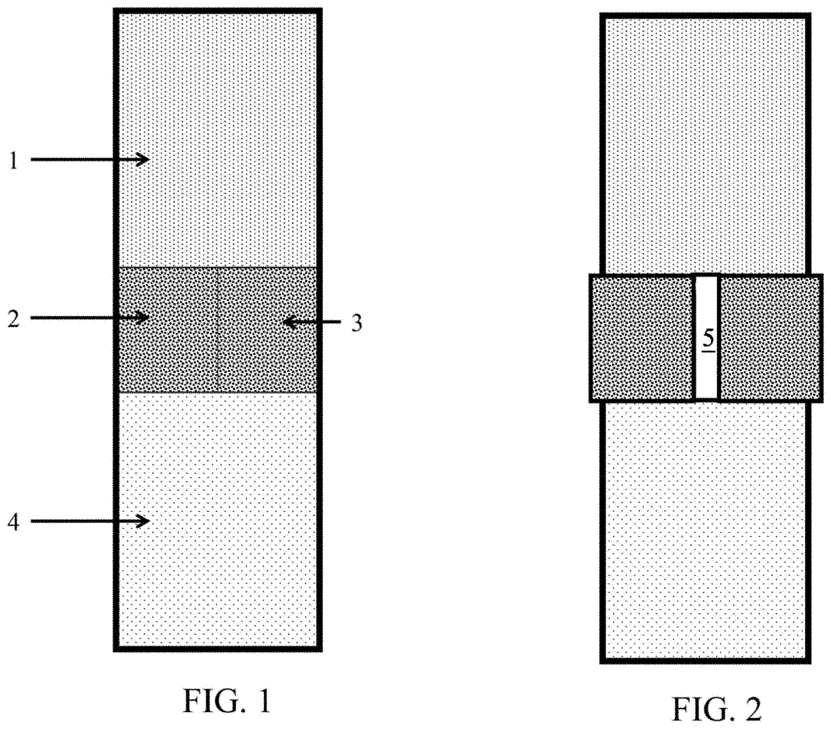

### DETAILED DESCRIPTION OF THE PREFERRED EMBODIMENTS

The following is a description of a preferred embodiment of a lightweight and packable support surface for patients to reduce the incidence of pressure-induced skin and soft tissue injury and related injuries that may affect care and treatment.

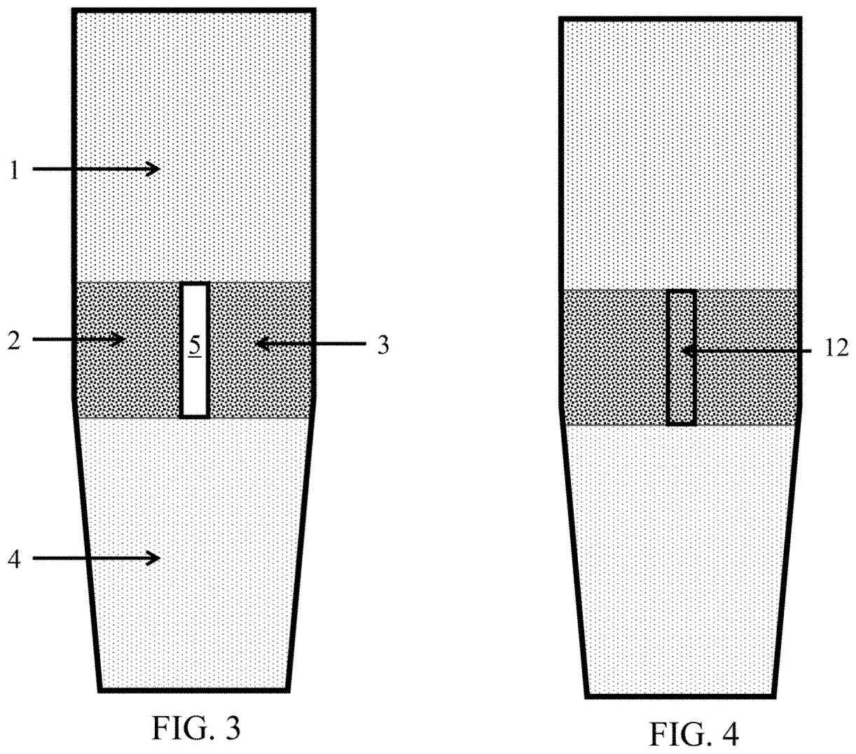

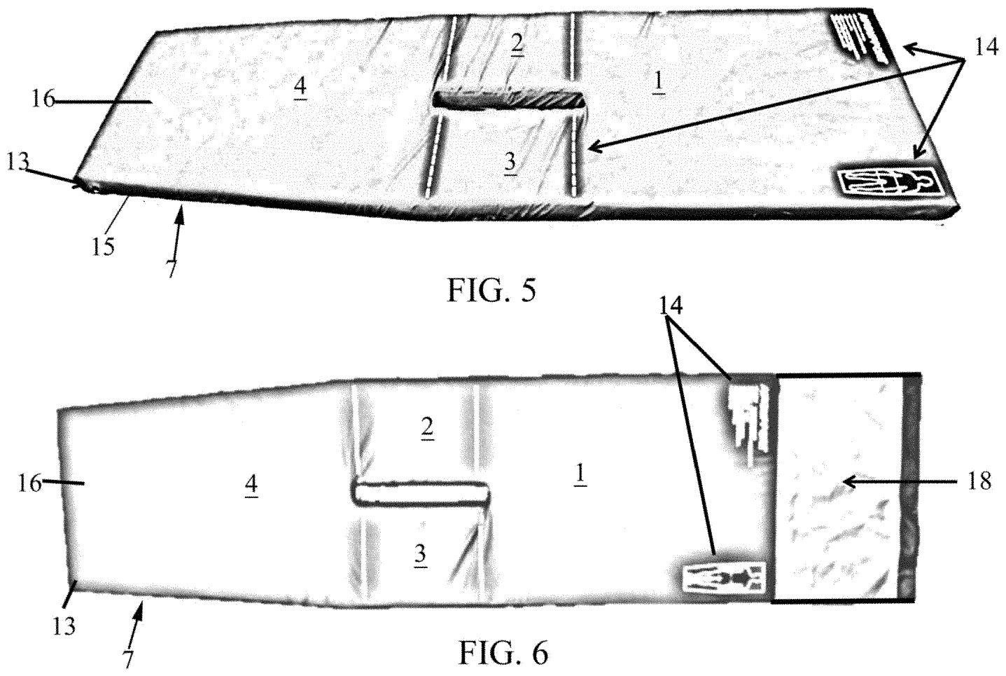

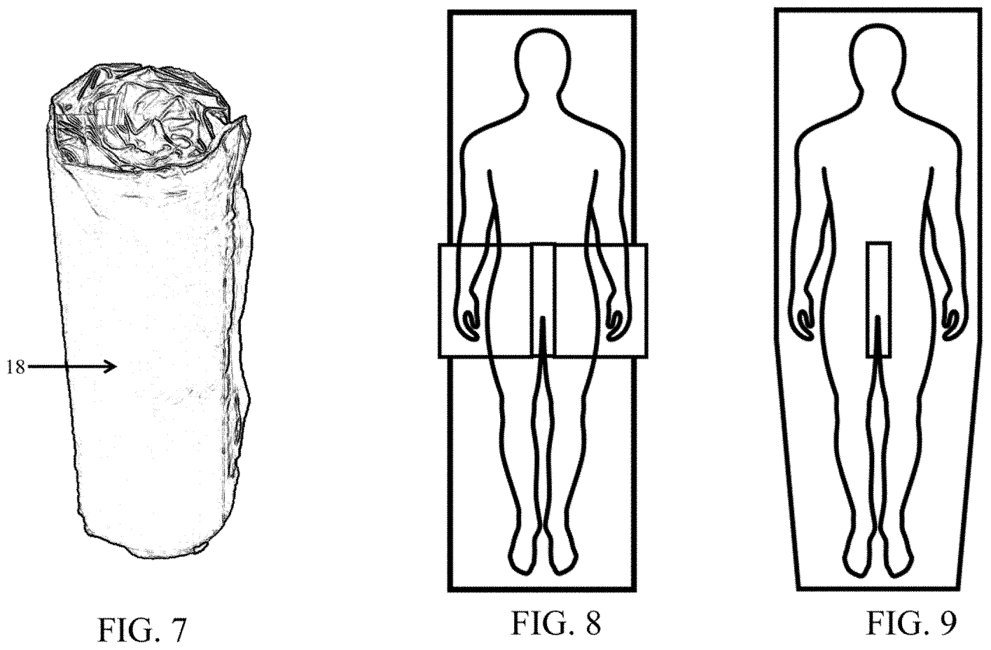

With reference to FIG. 3, an embodiment of the present invention comprises a rectangular support cushioning system with pads 1, 2, 3, and 4 of variable foam densities and stiffnesses. Additionally, the pads 1, 2, 3, and 4, can be composed of layers, or stack-up, of variable foam densities and stiffnesses. Candidate foam densities can range from 1.2-2.1 lbs/ft³. Candidate foam stiffnesses can range from 10-40 lbs as determined using a standardized Indentation Load Deflection test. A cut-out region 5 presents an area where the patient has little to no contact with the support cushioning system.

The overall rectangular shape is composed of identical upper and lower rectangular pads 1 and 4, separated by identical side-by-side and smaller rectangular pads 2, 3. All the support pads 1-4 preferably have a thickness of greater than 2 inches so that they do not get compressed to a point of densification (where the stress-strain relationship for the foam increases dramatically) when supporting a patient. Collapse and densification of the support pads 1-4 results in areas of elevated interface pressure on the patient resulting in increased likelihood of injury. To optimize weight, the support pads 1-4 preferably have a thickness of less than 4 inches. Specifically, support pads 1, 4 designed to support the shoulders, head, mid-thigh, and lower extremities are preferably composed of a thicker section of lower-density foam than support pads 2, 3 designed to support area between the lower torso and mid-thigh. Most preferably support pads 1, 4 are composed of a 3″ thick section of low-density foam with a density ranging between 1.2-1.8 lbs/ft³. Support pads 2, 3 designed to support area between the lower torso and mid-thigh are preferably composed of a 3″ thick stackup including a first layer of lower-density foam consisting 1.2-1.8 lbs/ft³ density foam which is 30-35% of the total thickness and 1.5-2.1 lbs/ft³ density foam for the remaining 65-70% of the thickness. Again, these densities, along with the overall thickness of the pads 1-4, reduce the likelihood of pressure related injuries to the patient.

The support cushioning system is expected to be used in aeromedical evacuation of injured patients. Devices used in civilian and military aviation environments must comply with flammability requirements. Compliant foams used in the support cushioning system use chemical additives in the foam fabrication process to result in flame retardant properties.

The support pads 1-4 are preferably designed or arranged to produce areas under the patient with little to no direct contact with the support surfaces. These areas with little or no direct contact with the patient enable increased air flow and reduce moisture and temperature at the patient interface, as well as completely offload areas around bony prominences that are otherwise prone to PSSTI.

One method of producing areas of little or no direct contact of the support surface with the patient is using discrete pads 1-4 arranged relative to produce a gap or space between the pads 1-4.

Another method of producing areas of little or no direct contact of the support surface with the patient is using a support surface with removable cut-outs. For example, as seen in FIG. 2, a cut-out region 5 can be used.

With reference to Error! Reference source not found., an alternate embodiment comprises a hexagonal support cushioning system with three rectangular pads 1, 2, 3, and one trapezoidal pad 4 formed as above with like thicknesses and foam densities. The overall hexagonal shape conforms to the body, with rectangular support pad 1 designed to support the shoulders and head, and trapezoidal support pad 4 tapering downward to conform to mid-thigh and below. A cut-out region 5 presents an area where the patient has little to no contact with the support cushioning system.

As seen in Error! Reference source not found. a support cushion insert 12 may be inserted into the cut-out region 5 and thereby used to reconfigure the support cushion system to fill the area 5 with little to no patient contact.

The pads 1-4 are preferably encapsulated by a vented and air- or water-sealed cover to protect the compressible material inside from being soaked by bodily fluids and or water, e.g., if being washed.

Error! Reference source not found. shows a support cushioning system in which all pads 1-4 are encapsulated within a cover 7 comprising top patient interfacing cover material 16, bottom cover material 15, pressure relief vent 13, and indicia 14 for proper placement of the patient on the support cushion. The cover material 15, 16 includes beneficial properties. For example, the top cover material 16 is preferably constructed from a layer of fabric material(s) to reduce PSSTI by minimizing friction with the patient's skin and stretching in two directions; reduce incidence of infection using antimicrobial or similar materials; reduce skin irritation using biocompatible materials; and reduce wetness by using moisture wicking materials. The bottom cover material 15 is preferably constructed of layer of fabric material(s) that provide ruggedness to abrasion, cutting, and puncture; and prevent water penetration. Cover materials that can stretch on the order of 100-200% in both directions (commonly referred to as warp and weft directions) allow the fabric to better conform to the patient's body without introducing friction and adding to the support provided by the foam materials. Also, bacteria, virii, and microbes that lead to infections may complicate patient care. A cover material 16 may incorporate additives including, but not limited to, silver and copper to reduce the incidence of infection due to these causes and are commonly termed antiseptic, antimicrobial, or antibacterial. Biocompatible materials that reduce the incidence of skin irritation may enhance patient care. Cover materials that reduce the incidence of skin irritation are commonly termed biocompatible.

Build-up of skin moisture and wetness may complicate patient care. Wetness can be caused by rain, spilled fluids, sweat, bodily fluids, or through open wounds. A top cover material 16 that minimizes moisture accumulation aim can aid in patient care.

The support cushioning system may be used in harsh and rugged environments with rocky and uneven ground, and may be abraded if dragged along the ground, cut by sharp stones, or punctured by stones or sticks. The bottom cover material 15 is abrasion and tear resistant to protect the integrity of the pad when used on rough surfaces. A bottom cover material 15 capable of handling such an environment would reduce degradation and damage to the support surface and preserve the pressure injury reduction capabilities.

Furthermore, the cover materials 15, 16 are preferably waterproof to prevent intrusion of fluids into the underlying foam material as this may impact the performance of the foam. Otherwise, introduction of moisture into foam support materials would degrade pressure injury reduction performance. Additionally, the support surface foam materials would entrap the moisture resulting in a heavier system with reduced packability. Waterproof cover materials 15, 16 reduce the impact of a wet environment on the performance of the support surface.

Fabric welding uses heat and pressure to join the top cover material 16 and bottom cover material 15. The cover material 15, 16 is also weldable to other fabrics as this produces a more consistent seam and also prevents fluid intrusion. The vent 13 enables air pressure to equalize between the environment and the internal foam components.

The absence of a vent 13 could result in a change in the skin interface reducing properties of the support cushion should there be a sudden change in air pressure. Sudden changes in air pressure could arise from a change in altitude such as during helicopter or airplane ascent and descent. The indicia 14 provide the user information on proper use and care of the support system.

Error! Reference source not found. shows a support cushion system with a fabric flap 18. This fabric flap 18 is used to assist in packing the support cushion system and holding the support cushion in the packed configuration. The fabric flap 18 may be permanently attached to the support cushion system. Alternately, the fabric flap 18 may be attached to the support cushion system using hook-and-loop, buttons, snaps, or similar mechanisms. The fabric flap 18 has additional hook-and-loop, buttons, snaps, or similar mechanisms properly placed to attach to itself when the support cushion system is packed and rolled. Additionally, the fabric flap may also include a pocket to store additional accessory items such as an inflatable pillow or inflatable bolster.

Error! Reference source not found. shows the support cushion system compressed and rolled to reduce overall volume. Furthermore, the fabric flap 18 is rolled along with the support cushion and uses mechanisms to hold it in the rolled configuration.

FIGS. 8-9 illustrate how the invention offloads the sacral region. The sacral region (sacrum) is at the bottom of the spine and lies between the fifth segment of the lumbar spine (L5) and the coccyx (tailbone). The sacrum is a triangular-shaped bone and consists of five segments (S1-S5) that are fused together. The present invention reduces compression of the sacral area by the-above-described combination of variable density and thicknesses of pads 1-4 as well as cutout 5. The sacral region is particularly susceptible to pressure related soft tissue injuries, particularly in the case of immobile patients. The soft tissue over the sacrum bone forms a bony prominence that carries the weight of the lower torso region. Incidence of injury increase further with moisture and fluid build-up at the sacrum region. Off-loading the sacrum region using a cutout 5 not only relieves pressure on the soft tissue, but also the area remains dry through fluid drainage and airflow. Increase in temperature further exacerbates pressure related injuries. Off-loading the sacral area enables air flow to cool the area.

FIG. 8 is a perspective view illustrating the pad system with the separated pads at the lower torso isolates the sacral region to reduce the likelihood of sacral pressure related injuries to the patient.

FIG. 9 is a perspective view illustrating how cutout 5 isolates the sacral region to reduce the likelihood of sacral pressure related injuries to the patient.

Having now set forth the preferred embodiments and certain modifications of the concepts underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

We claim:

1. A pressure injury relief system for patient recovery and transport, comprising:
a cushioning support having a plurality of adjacent padded regions of varying density, each padded region comprising an open-cell foam support material, and at least one cut-out region between opposing padded regions and configured to correspond to a patient's bony prominence when said patient lies on said cushioning support.

2. The pressure injury relief system of claim 1, further comprising a cover that encapsulates the padded regions of open cell foam support material.

3. The pressure injury relief system of claim 2, wherein said cover is comprised of a plurality of fabrics that are weldable to each other.

4. The pressure injury relief system of claim 3, wherein said cushioning support has a patient interfacing side on which said patient lies, and the fabric on said patient-interfacing side of said cover is waterproof, weldable, biocompatible, capable of bidirectional stretch, and antimicrobial.

5. The pressure injury relief system of claim 3, wherein said cushioning support has a non-patient interfacing side opposite said patient interfacing side, and the fabric on the non-patient interfacing side of said cover is waterproof, weldable, and tear resistant properties.

6. The pressure injury relief system of claim 1, where said foam support material is flame retardant.

7. The pressure injury relief system of claim 1, wherein said cushioning support is comprised of adjoined padded regions of varying density, each padded region having a density tuned for a corresponding region of the patient's body that it is supporting.

8. The pressure injury relief system of claim 7, wherein said adjoined padded regions are adhered to one another to define a contiguous foam support cushion.

9. The pressure injury relief system of claim 1, further comprising a separate plug of foam support material configured to be inserted into said cut-out region of said support foam material.

10. The pressure injury relief system of claim 2, further comprising a plurality of vents installed onto said cover to equalize pressure between the environment and said foam support materials.

11. The pressure injury relief system of claim 11, wherein said plurality of vents allow air transfer, but prevent water transfer.

12. The pressure injury relief system of claim 2, further comprising indicia on said cover to indicate proper placement of the patient on said system.

13. The pressure injury relief system of claim 2, further comprising a flap of fabric to assist in packing and holding said system into a rolled configuration.

14. The pressure injury relief system of claim 2, further comprising attachment mechanisms for straps and handholds.

15. The pressure injury relief system of claim 1, wherein said cushioning support is hexagonal to conform to the body including an upper rectangular padded region to support the shoulders, head and upper torso, two middle padded regions to support the lower torso and mid-thigh, and a lower trapezoidal pad to support mid-thigh and below.

16. The pressure injury relief system of claim 15, wherein the cut-out region is positioned between said two middle padded regions to reduce patient contact in the sacral area.

17. The pressure injury relief system of claim 16, wherein the padded regions are less than four inches thick.

18. The pressure injury relief system of claim 15, wherein the upper and lower padded regions are comprised of foam with a density ranging between 1.2-1.8 lbs/ft³.

19. The pressure injury relief system of claim 18, wherein the two middle padded regions are comprised of a first layer of foam with a density ranging between 1.2-1.8 lbs/ft³ and a second layer of foam with a density ranging between 1.5-2.1 lbs/ft³.

20. The pressure injury relief system of claim 19, wherein the second layer of foam is within a range of from 2.33 to 1.86 times thicker than said first layer of foam.

21. A pressure injury relief system for patient recovery and transport comprising of open-cell foam support material consisting of a plurality of regions, wherein each of said regions have a thickness and each region being separately tuned for the portion of the patient body that it is supporting.

22. The pressure injury relief system of claim 15, wherein said regions are tuned by varying the density or stiffness of the foam support material in said region.

23. The pressure injury relief system of claim 15, wherein said regions are adhered to one another to create a contiguous foam support.

24. The pressure injury relief system of claim 17, wherein each region of foam comprises a plurality of layers of open cell foam.

25. The pressure injury relief system of claim 19, wherein said different properties include foam density and foam stiffness.

26. The pressure injury relief system of claim 16, where there is a at least one cut-out region in the foam support material that is oriented to be underneath a patient's bony prominence.

27. The pressure injury relief system of claim 16, further comprising a cover that encapsulates said foam.

28. The pressure injury relief system of claim 22, wherein said cover is comprised of a plurality of fabrics that are weldable to each other.

29. The pressure injury relief system of claim 23, wherein said fabric on a patient-interfacing side of said cover has waterproof, weldable, biocompatible, capable of bidirectional stretch, and antimicrobial properties.

30. The pressure injury relief system of claim 23, wherein said fabric on a non-patient interfacing side of said cover has waterproof, weldable, and tear resistant properties.

31. The pressure injury relief system of claim 16, where said foam support materials are flame retardant.

32. The pressure injury relief system of claim 21, further comprising a separate plug of foam support material configured to be inserted into said cut-out region of said support foam material.

33. The pressure injury relief system of claim 22, further comprising a plurality of vents installed onto said cover to equalize pressure between the environment and said foam support materials.

34. The pressure injury relief system of claim 28, wherein said plurality of vents allow air transfer, but prevent water transfer to prevent water intrusion into said foam support material.

35. The pressure injury relief system of claim 22, further comprising indicia on said cover to indicate proper placement of the patient on said system.

36. The pressure injury relief system of claim 22, further comprising a flap of fabric to assist in packing and holding the support cushion into a rolled configuration.

37. The pressure injury relief system of claim 22, further comprising attachment mechanisms for straps and handholds.
